(19) United States
(12) Patent Application Publication
(10) Pub. No.: US 2009/0179724 A1
(43) Pub. Date: Jul. 16, 2009

(54) Power Inductor

(76) Inventors: Kan Sano, Tokyo (JP); Tsutomu Watanabe, Tokyo (JP)

Correspondence Address: VON SIMSON & CHIN, 62 WILLIAM STREET, 6TH FLOOR, NEW YORK, NY, 10005, US

(21) Appl. No.: 12/093,585

(22) PCT Filed: Oct. 10, 2006
(86) PCT No.: PCT/JP2006/320183

§ 371 Date: Dec. 30, 2008

(30) Foreign Application Priority Data
Nov. 14, 2005 (JP) 2005-328599

(51) Int. Cl. H01F 17/04

(52) U.S. Cl. 336/221

(57) ABSTRACT

The invention is to provide an inductor which can flow a high frequency current and a large current. An inductor for a power source used in a power source circuit flowing a current larger than a current in an inductor for signal transmission comprises a core provided with a center core for winding and a coil provided with the centre core and a conductive member wound around the center core. A frequency band of a current applied to the coil is from 5 MHz to 10 MHz and a frequency ratio of a standard frequency lower than the used frequency band to the used frequency band is approximately equal to an alternative current resistance ratio of an alternative current resistance at the standard frequency to an alternative current resistance at the used frequency band.

### TECHNICAL FIELD

The present inventions relate to an inductor for a power source used as a power source for various electric devices, such as mobile phones and the like.

1. Background of the Invention

A various electric devices like a mobile phone and a note type personal computer include a power source circuit such as a AC/DC converter. An inductor for a power source functioning as a chalk coil and the like, for example, is generally mounted in such power source circuit. A current which is larger than a current for an inductor used for removing a noise of a signal for example, can be applied to such inductor for a power source. The patent document 1 discloses an example of an inductor for a power source mounted in a power source circuit. The coil with wound enamel wires disclosed in the patent document 1 further is disposed in a drum core.

2. Prior Art

Japanese Patent Application Laid-Open No. 2003-115409 (refer to the paragraph number 0012, FIG. 1,2 and others and the like)

### DETAILED DESCRIPTION

By the way, it is recently requested that an inductor for a power source mounted on power source circuit referred to above can handle not only a large current, but a high frequency current. On the other hand, a high frequency current of which band is over 5 MHz for example cannot be applied to the inductor for a power source disclosed in the prior art. Namely, an alternative current resistance is a main cause of a power loss in such high frequency. However an inductor for a power source largely reducing such power loss currently does not exist. Namely, the current inductor for a power source has a disadvantage of insufficiency of handling a high frequency current as well as a large current which is required in the markets in future.

In order to overcome the above-described circumstances, the present invention is to provide an inductor for a power source which is able to handle a high frequency current and a large current.

According to an aspect of the invention, an inductor for a power source used in a power source circuit into which a current larger than a current flowing into an inductor for a signal flows, comprises: a core having a center core for winding; a coil formed by winding conductive member around center core and a conductive member wound around the center core; and a resistance restraining means that restrains an increase of an alternative current resistance in the coil. A frequency band of a current applied to the coil is from 5 MHz to 10 MHz and a frequency ratio of a standard frequency lower than the used frequency band to the used frequency band is approximately equal to an alternative current resistance ratio of an alternative current resistance at the standard frequency to an alternative current resistance at the used frequency band.

In this structure, a used frequency band is from 5 MHz to 10 MHz, namely high frequency. In this case, the resistance restraining means keeps the alternative current resistance constant and avoids a sharp increased curve of it even if a used frequency band is high frequency such as 5 MHz to 10 MHz. This means enables the inductor to handle a high frequency current and a large current.

According to other aspect of the invention, in addition to the above mentioned invention, the conductive member comprises a conductive part for passing a current, a magnetic layer surrounding the periphery of the conductive part and an insulating member surrounding the periphery of the magnetic layer. The resistance restraining means includes the magnetic layer and the core is a drum type-core provided with two flanges.

In the above structure, the magnetic layer surrounds the periphery of the conductive part of the conductive member and the magnetic layer corresponds to the resistance restraining means, restraining a skin effect generated when a high frequency current flows, and a proximity effect when forming the coil. Hence, it is possible to decrease an alternative current resistance in the coil and handle a high frequency current and a large current.

The invention provides an inductor for a power source which can handle a high frequency current and a large current.

### BRIEF DESCRIPTION OF THE DRAWINGS

FIG. 1 is a side view showing an overall configuration of an inductor regarding an embodiment of the invention.

FIG. 2 is a plain view of the configuration of the inductor shown in FIG. 1.

FIG. 3 is a bottom view of the configuration of the inductor shown in FIG. 1.

FIG. 4 is a cross section of the inductor shown in FIG. 1 including a structure of a conductive member.

FIG. 5 is a diagram of an example showing a relationship between a frequency and an alternative current resistance regarding the inductor shown in FIG. 1.

FIG. 6 is a diagram of other example showing a relationship between a frequency and an alternative current resistance regarding the inductor shown in FIG. 1.

10: inductor,

20: drum type core,

30: coil,

31: conductive member,

31a: conductive portion,

31b: magnetic layer (corresponding to a resistance restraining means),

31c: insulating film,

40: terminal for mounting.

### THE PREFERRED EMBODIMENTS OF THE INVENTION

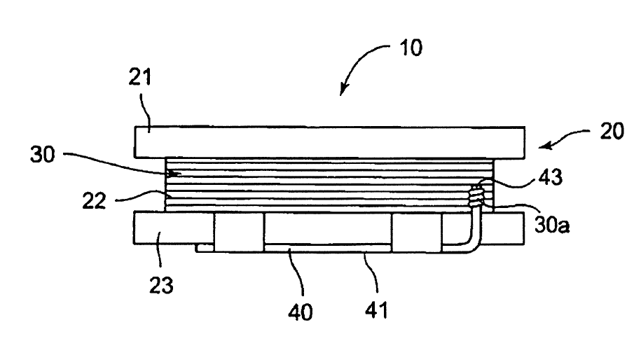

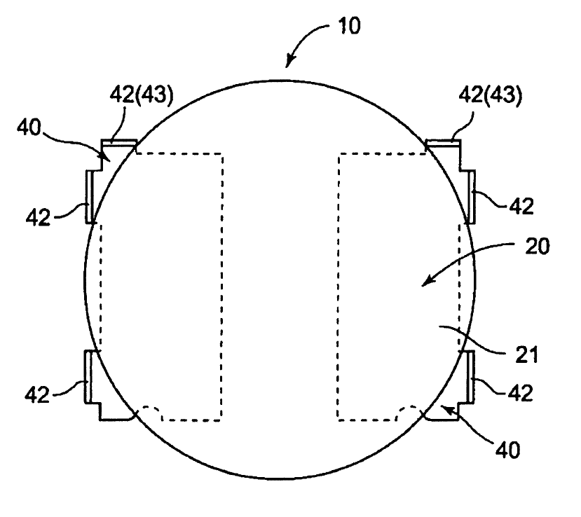

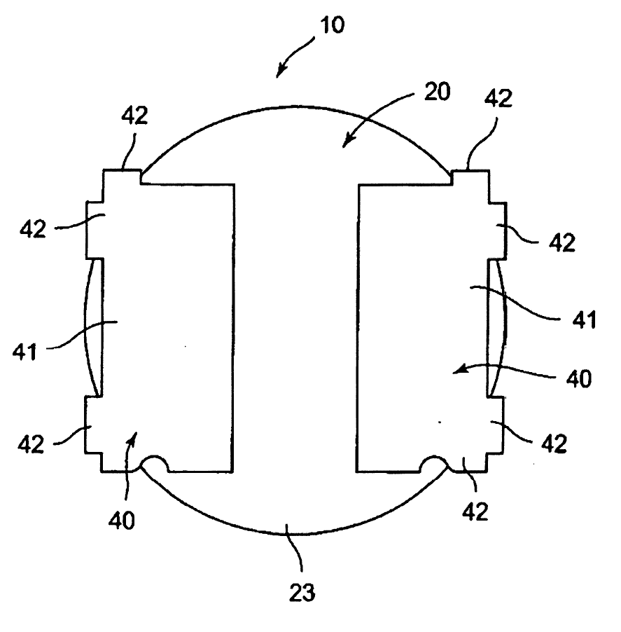

An inductor for a power source (in the following description, simply called as an inductor) according to an embodiment of the present invention will be described referring to FIG. 1 to FIG. 6. FIG. 1 is a side view showing an overall configuration of an inductor 10 regarding an embodiment of the invention. FIG. 2 is a plain view of the configuration of the inductor 10. FIG. 3 is a bottom view of the configuration of the inductor 10. It should be noted that, in the following description, the side in which an upper flange portion 21 exists is defined as an upper side viewing from the lower flange portion 23 and the side in which a lower flange portion 23 exists is defined as a lower side viewing from the upper flange portion 21.

The inductor 10 shown in FIG. 1 to FIG. 3 is mounted on a power source circuit such as a AC/DC converter as a chopper coil used for boosting or stepping down for example. The inductor 10 comprises a drum type core 20, coil 30 and a mounting terminal 40. The drum type core 20 is made of a material which has high frequency property and high magnetic density, such as an iron core, a ferrite core and the like.

The drum type core 20 comprises the upper flange portion 21, the center core 22 and the lower flange portion 23. The upper flange portion 21 and lower flange portion 23 has an almost disk shape having a predetermined thickness. The center core 22 is a part connecting the upper flange portion 21 with the lower flange portion 23 toward a height direction. The diameter of the center core 22 is smaller than that of the upper flange portion 21 and lower flange portion 23. By winding a conductive member 31 described below around the periphery of the center core 22, a coil 30 is formed.

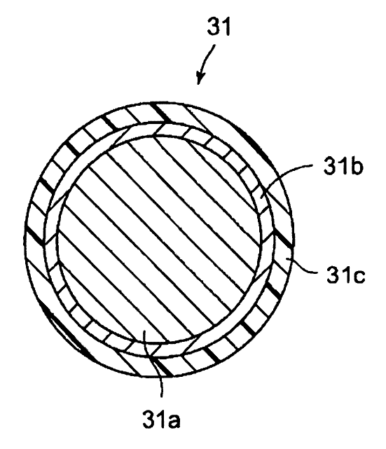

The coil 30 according to an embodiment of the present invention is formed by winding the conductive member 31 shown in FIG. 4. In the conductive member 31 shown in FIG. 4, a magnetic layer 31b (as a resistance restraining means) as a ferromagnetic body is surrounding the conductive portion 31a for passing a current. And also the outside of the magnetic layer 31b is covered over by an insulating film 31c. The coil 30 is formed by winding the conductive member 31 with predetermined numbers.

More specifically, the magnetic layer 31b is a part covering the surrounding of the conductive portion 31a such as plating and made of thin layer of a ferromagnetic such as iron, for example. The insulating layer 31c is a film made of a polyurethane resin in which polyol is cross-linked with isocyanate, located at the most circumferential area. However the material of the insulating film 31c is not limited to a polyurethane resin, but other resins or other insulating material.

A terminal 30a of the coil 30 is connected to the mounting terminal 40. As shown in FIG. 1 to 3, the mounting terminal 40 is formed by cutting a metal thin plate and folding it. In the mounting terminal 40, the bottom terminal portion 41 located at the lower side of the lower flange portion 23 is a portion connecting to a mounting part of the power source circuit not shown in the figure. A nail part 42 is formed in the mounting terminal 40 by folding and works as positioning toward the lower flange portion 23. In the embodiment of the present invention, four nail portions 42 are formed per the terminal portion 41. Two nail portions 42 are formed in the area close to the corner of the outer circumference in the bottom terminal portion 41. And the two nail portions 42 adjacently located to each other are formed with the angle of 90 degree to each other. Then the terminal of the coil 30 (the conductive member 31) is located in-between nail portions 42 adjacently located to each other and jointed to the mounting terminal 40 by various bonding means such as soldering and laser welding.

As shown in FIG. 1 and others, an engaging terminal 43 is installed in the pair of the mounting terminals 40. The engaging terminal 43 is formed by steering and stretching any of nail portions 42 toward an upper direction. The terminal 30a of the coil 30 is engaged in the engaging terminal 43. In the meantime the terminal 30a may be welded to an edge portion of the bottom terminal portion 41 while it is engaged in the engaging terminal 43.

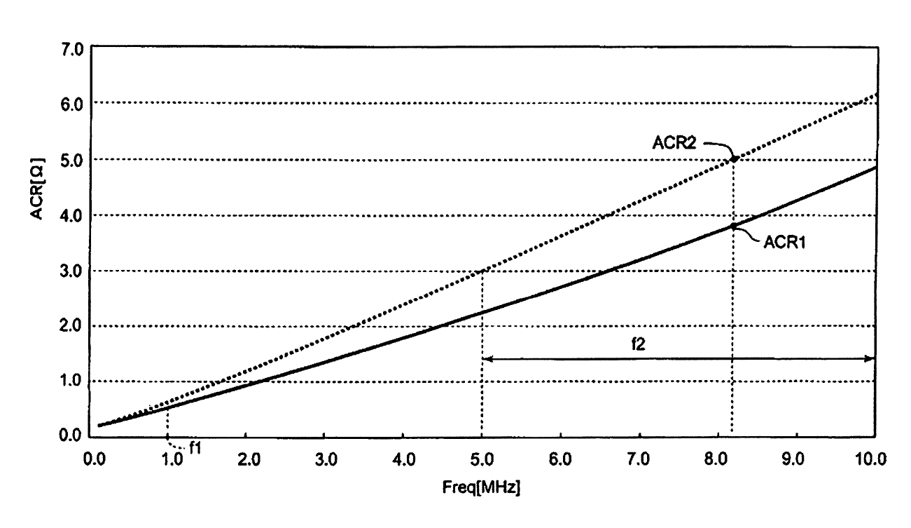

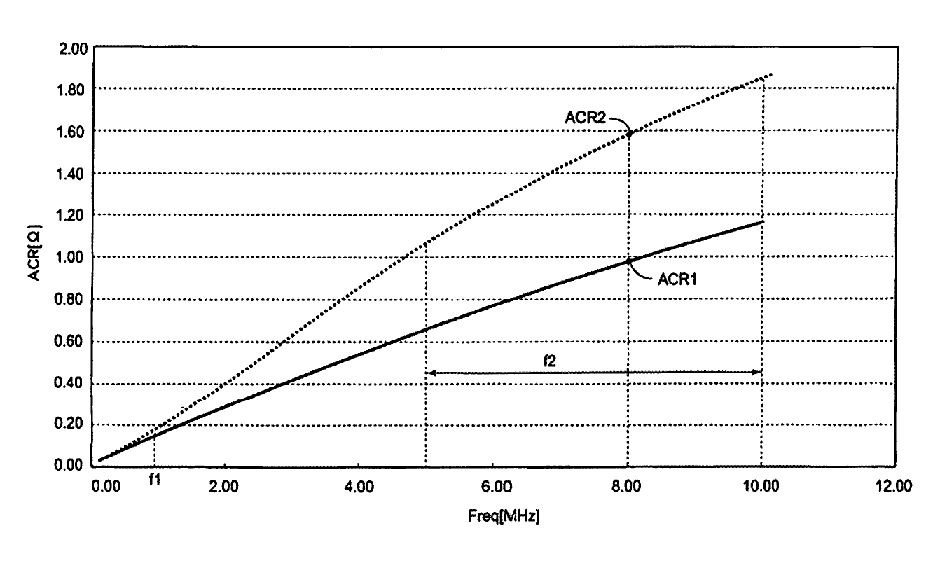

Experimental results regarding the property of the inductor 10 which has the configuration referred above will be described referring to FIG. 5 and FIG. 6.

FIG. 5 shows an example of the relationship between a frequency and an alternative resistance regarding the inductor 10 of the embodiment of the present invention and the conventional inductor. In the relationship shown in FIG. 5, the inductance value is 2.2 μH and the winded numbers are 12.5T. A solid line shows the property of the inductor 10 of the embodiment and a broken line shows the property of the conventional inductor.

As shown in FIG. 5, the alternative current resistance ACR1 of the inductor 10 of the embodiment of the present invention is lower than the alternative current resistance ACR2 of the conventional inductor when they are compared to each other at the same frequency. In particular, the ratio of ACR1 to ACR2 is lower by about 27% around 5 MHz and the ratio is lower by about 25% around 8 MHz when they are compared to each other in the region from 5 MHz to 10 MHz. In FIG. 5, the standard frequency F1 is 1 MHz and the used frequency band F2 to the standard frequency F1 is from 5 MHz to 10 MHz. If these parameters are compared, the following formula is established:

F1/F2≈ACR1/ACR2 (1)

In this formula (1), the symbol “≈” meaning approximately equal is used. The range of the approximation is 1±0.3.

Namely, the alternative current resistance ACR2 is lowered though the used frequency band F2 moves toward a higher range if the inductor 10 is compared to the conventional inductor used in the frequency band under 1 MHz. This lowering of the alternative current resistance ACR2 enables the inductor 10 of the embodiment of the present invention to reduce a power loss at the time of passing a large current compared to the conventional inductor for a power source.

FIG. 6 shows other example of the relationship between a frequency and an alternative resistance regarding the inductor 10 of the embodiment of the present invention and the conventional inductor. The inductance value is 10 μH and the winded numbers are 5.5T in the relationship shown in FIG. 6. Similarly to FIG. 5, a solid line shows the property of the inductor 10 of the embodiment and a broken line shows the property of the conventional inductor.

As shown in FIG. 6, the ratio of ACR1 to ACR2 is lower by about 38% around 5 MHz and the ratio is lower by about 38% around 10 MHz when the inductor 10 is compared to the conventional inductor at the same frequency. The formula (1) described above is approximately applied to other example in FIG. 6. Here, the standard frequency F1 is not limited to 1 MHz, but can be set to any of various values lower than the used frequency band F2.

In this structure of the inductor 10, the alternative current resistance does not go up with a sharp curve even if the used the current of high frequency band such as 5 to 10 MHz. Namely, as the conductive member 31 constituting the coil 30 comprises the magnetic layer 31b, making it possible to restrain a skin effect when flowing a high frequency current and a proximity effect when forming the coil. Hence, it is possible to decrease an alternative current resistance in the coil 30 and handle a high frequency current such as 5 to 10 MHz and a large current.

Further, restraining an alternative current resistance as described above can constrain amount of heating in the power source circuit. Namely, it is possible to overcome an issue of heating which is occurred when a large current flows in the inductor 10. Further, restraining heating amount can extend a life of the inductor 10.

The above-described embodiment about the inductor 10 can be modified as the following.

In the above-described embodiment, the conductive member 31 having a circular wire is used as a coil. However, the conductive member 31 is not limited to a circular wire, but may be a plate-shaped conductive member to form a coil. In the above embodiment, the insulating film 31b is comprised in the conductive member 31. However, the insulating film 31b may not be formed in the inductor.

Further, in the above-described embodiment, the drum type core 20 having an open magnet is disposed in the inductor 10. However, the inductor may be provided with other core more than a drum type core having an open magnet. For example, a ring type core may be located like a ring around the periphery of the drum type core.

In the above-described embodiment, the inductor 10 which has the single coil 30, used as a chopper coil in a power source circuit such as a AC/DC converter is explained. However, the inductor of the invention may be provided with a transformer including two or more coils.

The inductor of the present invention can be used in electric appliances.

What is claimed is:

1. An inductor for a power source used in a power source circuit flowing a current larger than a current in an inductor for signal transmission comprising:
a core having a center core for winding;
a coil formed by winding conductive member around the center core; and
a resistance restraining means for restraining an alternative current resistance in the coil, wherein
a frequency band of a current applied to the coil is from 5 MHz to 10 MHz and a frequency ratio of a standard frequency lower than the used frequency band to the used frequency band is approximately equal to an alternative current resistance ratio of an alternative current resistance at the standard frequency to an alternative current resistance at the used frequency band.

2. The inductor for a power source according to claim 1, wherein the conductive member comprises a conductive part for passing a current, a magnetic layer surrounding the periphery of the conductive part and an insulating member surrounding the periphery of the magnetic layer and wherein
the resistance restraining means is made of a magnetic layer and the core is a drum type core having two flange portions.
